(19) United States
(12) Patent Application Publication
(10) Pub. No.: US 2011/0220277 A1
(43) Pub. Date: Sep. 15, 2011

(54) Eliminating Joint Lines In Furniture

(76) Inventor: Gosakan Aravamudan, Bangalore (IN)

(21) Appl. No.: 13/130,308

(22) PCT Filed: Nov. 19, 2009
(86) PCT No.: PCT/IN2009/000664

§ 371 Date: May 20, 2011

(30) Foreign Application Priority Data
Nov. 25, 2008 (IN) 2929/CHE/2008

(51) Int. Cl. B32B 37/24; B32B 37/02; B32B 37/10; B32B 38/10

(52) U.S. Cl. 156/247

(57) ABSTRACT

A method of manufacturing a furniture body is provided. A release sheet, for example, a silicone rubber sheet, deposited with an uncured artificial stone mix is placed on a surface. A central core comprising, for example, paper honeycomb, is placed on the release sheet deposited with uncured artificial stone mix. Decorative materials, for example, ornamental glass, semiprecious stones, etc. may be included on the release sheet. Pressure may be applied to compact the artificial stone mix deposited with a backing of glass fiber and resin. The central core is wrapped with the release sheet deposited with the uncured artificial stone mix. The release sheet is removed after the deposited artificial stone mix is partially or fully cured over the central core. The wrapping provides a continuous surface of the artificial stone mix over the sides, edges, corners, and curved surfaces of the central core, thereby eliminating joint lines.

### CROSS REFERENCE TO RELATED APPLICATIONS

This application claims the benefit of the following patent applications:
1. Provisional patent application number 2929/CHE/2008 titled “Eliminating Joint Lines In Furniture”, filed on Nov. 25, 2008 in the Indian Patent Office.
2. PCT application number PCT/IN2009/000664 titled “Eliminating Joint Lines In Furniture”, filed on Nov. 19, 2009 in the Indian Patent Office.

The specifications of the above referenced patent applications are incorporated herein by reference in their entirety.

### BACKGROUND

This invention, in general, relates to building structures. More particularly, this invention relates to a body structure for furniture and building structures, for example, doors, tables and windows.

When planar surfaces are used to manufacture furniture, such as wood planks or thin stone sheets, the joints between the wood planks or between the thin stone sheets are difficult to eliminate and are visually displeasing. There is a need to eliminate these aesthetically displeasing joint lines. There is also a need to eliminate the additional process of jointing in the manufacture of furniture or building structures.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method of manufacturing a furniture body disclosed herein addresses the above stated unmet need for eliminating aesthetically displeasing joint lines created during the manufacture of furniture. The method disclosed herein comprises the steps of: placing a layer of a release sheet on a surface; depositing an uncured artificial stone mix on the release sheet; placing a central core on the release sheet deposited with the uncured artificial stone mix; wrapping the central core with the release sheet deposited with the uncured artificial stone mix; and removing the release sheet after allowing the deposited artificial stone mix to partially or fully cure over the central core. The wrapping provides a continuous surface of the artificial stone mix over the sides, edges, corners, and curved surfaces of the central core, thereby eliminating the joint lines.

The central core is a lightweight core comprising one or a combination of porous ceramic blocks, paper honeycomb, structural polyurethane foam, etc. Multiple decorative materials comprising, for example, ornamental glass, semiprecious stones, metal art, colored quartz, glass jewelry, stone jewelry, etc. may be included on the release sheet. A metal grid may be inserted in the central core for additional reinforcement. The release sheet is, for example, one or more of a polyethylene terephthalate sheet, a plastic sheet, a silicone rubber sheet, a rubber sheet, and a polytetrafluoroethylene sheet. After the deposition of the uncured artificial stone mix on the release sheet, the following additional processes may be exercised. For example, pressure may be applied on the deposited artificial stone mix. A backing of glass fiber and resin may be applied to the deposited artificial stone mix. Vibro-compaction may be applied to the deposited artificial stone mix for better compaction. Vibro-compaction in a vacuum may also be applied to the deposited artificial stone mix to release entrapped volatiles and air.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of manufacturing a furniture body.

FIG. 2 exemplarily illustrates multiple decorative materials placed on a release sheet.

FIG. 3 exemplarily illustrates an artificial stone mix deposited on the release sheet.

FIG. 4 exemplarily illustrates the process of wrapping the release sheet deposited with the artificial stone mix over a central core.

FIG. 5 exemplarily illustrates the central core wrapped with the release sheet deposited with the artificial stone mix.

FIG. 6 exemplarily illustrates the process of removing the release sheet wrapped over the central core after partial or full curing of the artificial stone mix.

### DETAILED DESCRIPTION OF THE INVENTION

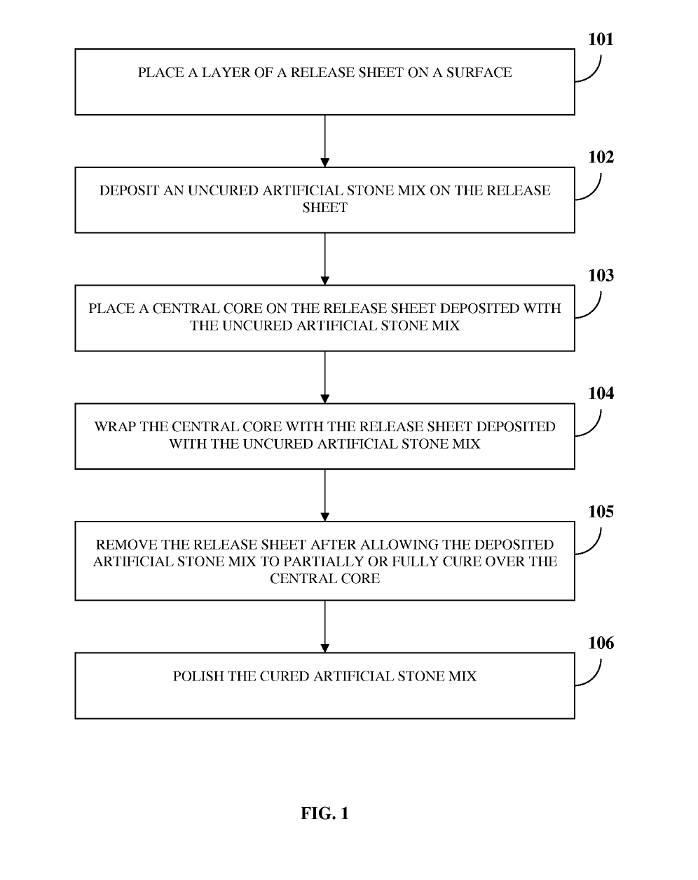

FIG. 1 illustrates a method of manufacturing a furniture body. The method disclosed herein comprises the steps of: placing 101 a layer of a release sheet on a surface; depositing 102 an uncured artificial stone mix on the release sheet; placing 103 a central core on the release sheet deposited with the uncured artificial stone mix; wrapping 104 the central core with the release sheet deposited with the uncured artificial stone mix; and removing 105 the release sheet after allowing the deposited artificial stone mix to partially or fully cure over the central core. The wrapping provides a continuous surface of the artificial stone mix over the sides, edges, corners, and curved surfaces of the central core, thereby eliminating the joint lines. The cured artificial stone mix is then polished 106.

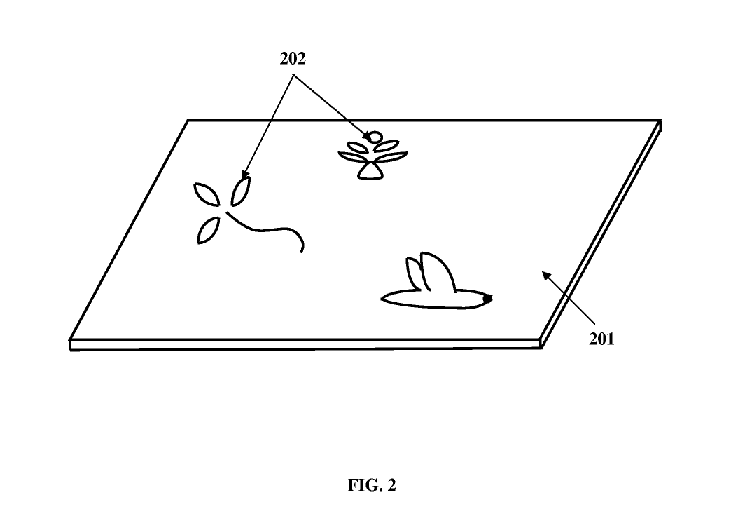

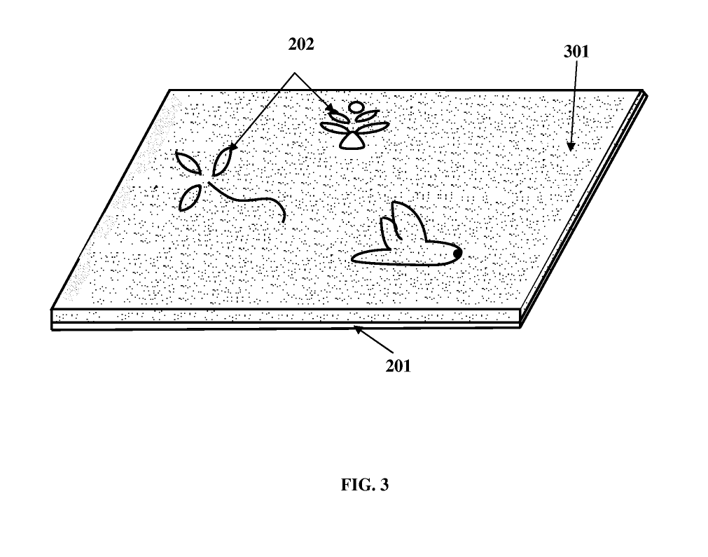

FIGS. 2-6 exemplarily illustrate the manufacture of the furniture body 600. A layer of a release sheet 201 is placed on a surface as exemplarily illustrated in FIG. 2. The release sheet 201 is, for example, one or more of a polyethylene terephthalate sheet, a plastic sheet, a silicone rubber sheet, a rubber sheet, and a polytetrafluoroethylene sheet. Multiple decorative materials 202 are included on the release sheet 201 as exemplarily illustrated in FIG. 2. The decorative materials 202 comprise, for example, one or more of ornamental glass, semiprecious stones, metal art, colored quartz, glass jewelry, stone jewelry or a combination thereof. An uncured artificial stone mix 301 is deposited on the release sheet 201 as exemplarily illustrated in FIG. 3.

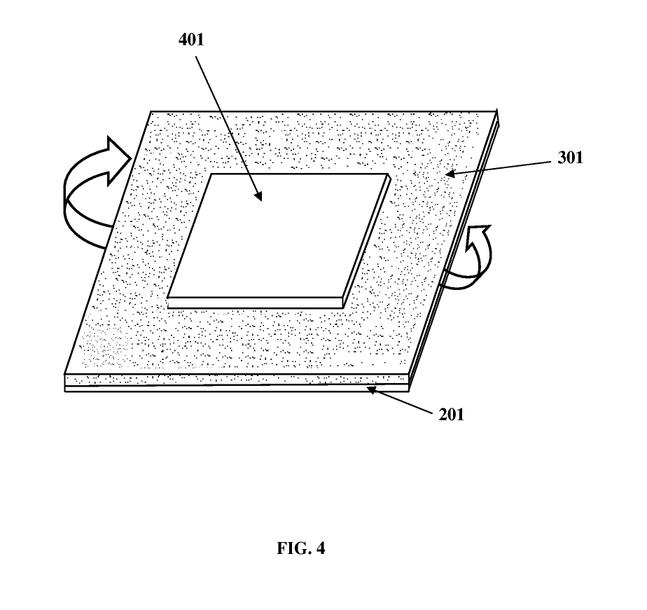

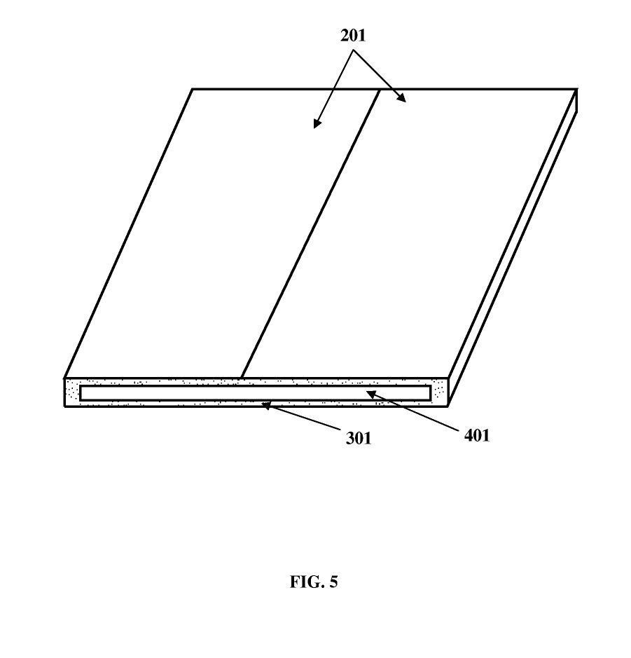

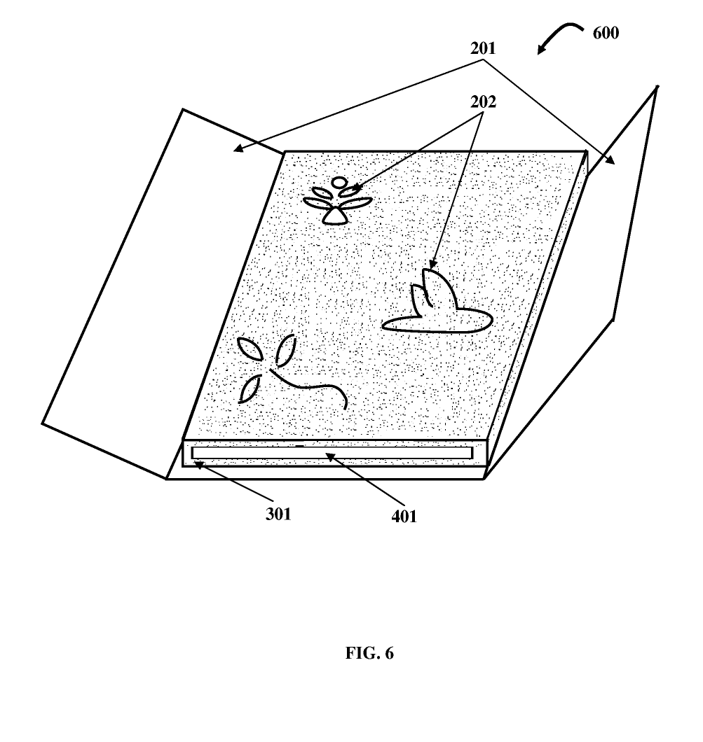

A central core 401 is placed on the release sheet 201 deposited with the artificial stone mix 301 as exemplarily illustrated in FIG. 4. The central core 401 is, for example, a lightweight core comprising one or more of porous ceramic blocks, paper honeycomb, structural polyurethane foam, or a combination thereof. In an embodiment, a metal grid (not shown) is inserted in the central core 401 for additional reinforcement. The central core 401 is wrapped with the release sheet 201 deposited with the uncured artificial stone mix 301. The process of wrapping the release sheet 201 deposited with the artificial stone mix 301 over the central core 401 is exemplarily illustrated in FIG. 4. The wrapped central core 401 is exemplarily illustrated in FIG. 5. The artificial stone mix 301 is allowed to partially or fully cure over the central core 401. The release sheet 201 is then removed from the partially or fully cured artificial stone mix 301. The decorative materials 202 included on the release sheet 201 get embedded in the cured artificial stone mix 301 when the release sheet 201 is removed. The process of removing the release sheet 201 wrapped over the central core 401 after partial or full curing of the artificial stone mix 301 is exemplarily illustrated in FIG. 6. The partially cured artificial stone mix 301 is allowed to cure completely at room temperature. The fully cured artificial stone mix 301 is polished. The wrapping provides a continuous surface of the artificial stone mix 301 over the sides, edges, corners, and curved surfaces of the central core 401, thereby eliminating joint lines.

In an embodiment, pressure is applied on the uncured artificial stone mix 301 for better compaction. In another embodiment, a fiber layer is placed on the compacted artificial stone mix 301 and coated with a resin for improved handling during the wrapping process and for improving the mechanical strength of the furniture body 600. The fiber is, for example, a glass fiber.

In another embodiment, vibro-compaction is applied to the deposited artificial stone mix 301 for better compaction. Vibro-compaction in a vacuum may also be applied to the deposited artificial stone mix 301 to release entrapped volatiles and air.

The artificial stone mix 301 comprises particulates and resin. The particulates comprise, for example, one or more of quartz, granite, glass, ceramic etc. The size of the particulates, for example, varies from fine powder to about 4 mm. The size distribution may follow Fuller's formula to achieve maximum compaction. The resin is, for example, a polyester resin. An example of a polyester resin is a combination of about 80% of ortho neo pentyl glycol and about 20% of styrene monomer. Another example of a polyester resin is a combination of about 80% of ortho neo pentyl glycol, about 10% of methyl acrylate monomer and about 10% of styrene monomer. Room temperature catalysts, for example, methyl ethyl ketone peroxide (MEKP) and room temperature accelerators may be used for curing the resin. In another embodiment, high temperature setting catalysts, for example, dimethyl aniline (DMA) are used for curing the resin. The artificial stone mix 301 may also be a cement based mix. The cement is, for example, Portland cement.

Examples 1, 2 and 3 are example compositions of the artificial stone mix 301.

### Example 1

| Ingredient | Parts By Weight |
|---|---|
| Unsaturated Polyester resin solution | 14 |
| (Unsaturated polyester resin, | |
| styrene monomer, | |
| methyl methacrylate monomer) | |
| Quartz (particles size <4.0 mm) | 84 |
| Benzoyl peroxide | 1 |
| Dimethyl Aniline (DMA) | 1 |

Curing is carried out at 70 deg Celsius for 15 minutes.

### Example 2

| Ingredient | Parts by weight |
|---|---|
| Unsaturated Polyester resin solution | 12 |
| (Unsaturated polyester resin, | |
| styrene monomer) | |
| Quartz (particles size <4.0 mm) | 86 |
| Benzoyl peroxide | 1.0 |
| Dimethyl Aniline (DMA) | 1.0 |

Curing is carried out at 70 deg Celsius for 15 minutes.

### Example 3

| Ingredient | Parts by weight |
|---|---|
| Unsaturated Polyester resin solution | 10 |
| (Unsaturated polyester resin, | |
| styrene monomer, | |
| methyl methacrylate monomer) | |
| Quartz (particles size <4.0 mm) | 89 |
| Methyl ethyl ketone peroxide (MEKP) | 0.5 |
| Cobalt Naphthenate | 0.5 |

Curing is carried out at room temperature.

Finally, the surface of the furniture body 600 is polished by typical polishing techniques applied in granite polishing.

### Example 4

This example illustrates the manufacture of a furniture body 600, for example, a table-top. A release sheet 201, for example, a polyethylene terephthalate sheet, is placed on a flat floor. The artificial stone mix 301 having the composition disclosed in example 3 above is deposited on the polyethylene terephthalate sheet. Another polyethylene terephthalate sheet is placed over the deposited artificial stone mix 301 and rolled with a heavy roller to compact the artificial stone mix 301. The polyethylene terephthalate sheet is removed and a layer of glass fiber is deposited on the compacted artificial stone mix 301. The glass fiber layer is wetted with an unsaturated polyester resin containing a catalyst, for example, methyl ethyl ketone peroxide (MEKP) and an accelerator, for example, cobalt naphtenate. A central core 401 comprising, for example, structural polyurethane foam, is placed on the resin coated glass fiber layer. The polyethylene terephthalate sheet along with the compacted artificial stone mix 301 and the coated glass fiber layer is wrapped over the structural polyurethane foam on all sides. The lines of contact from the wrapping process are made planar by rolling with a hand held light weight roller. The artificial stone mix 301 is allowed to cure over a period of 48 hours at room temperature. The polyethylene terephthalate sheet is removed from the cured artificial stone mix 301. The cured artificial stone mix 301 is polished is several stages using a rotary head polishing machine. Diamond polishing pads from, for example, about 60 grit to about 3000 grit are used for polishing. Each grit size is used in a single stage to create the table-top.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A method of manufacturing a furniture body, comprising:
placing a layer of a release sheet on a surface;
depositing an uncured artificial stone mix on said release sheet;
placing a central core on said release sheet deposited with said uncured artificial stone mix;
wrapping said central core with said release sheet deposited with said uncured artificial stone mix; and
removing said release sheet after allowing said deposited artificial stone mix to partially or fully cure over said central core;
wherein said wrapping provides a continuous surface of said artificial stone mix over the sides, edges, corners, and curved surfaces of said central core whereby joint lines are eliminated.

2. The method of claim 1, wherein said central core is a lightweight core comprising one or a combination of porous ceramic blocks, paper honeycomb, and structural polyurethane foam.

3. The method of claim 1, further comprising inclusion of a plurality of decorative materials on said release sheet, wherein said decorative materials comprise one or more of ornamental glass, semiprecious stones, metal art, colored quartz, glass jewelry, and stone jewelry.

4. The method of claim 1, further comprising insertion of a metal grid in said central core.

5. The method of claim 1, wherein said release sheet is one or more of a polyethylene terephthalate sheet, a plastic sheet, a silicone rubber sheet, a rubber sheet, and a polytetrafluoroethylene sheet.

6. The method of claim 1, wherein after said deposition of said uncured artificial stone mix on said release sheet, the following additional processes are exercised:
applying pressure on said deposited artificial stone mix; and
applying a backing of glass fiber and resin to said deposited artificial stone mix.

7. The method of claim 6, further comprising application of vibro-compaction to said deposited artificial stone mix.

8. The method of claim 6, further comprising application of vibro-compaction in a vacuum to said deposited artificial stone mix.
